(19) United States
(12) Patent Application Publication
(10) Pub. No.: US 2016/0242542 A1
(43) Pub. Date: Aug. 25, 2016

(54) FURNITURE DRIVE

(71) Applicant: Julius Blum GmbH, Hoechst (AT)

(72) Inventors: Gerald FRIESENECKER, Lauterach (AT); Wolfgang BOHLE, Goetzis (AT)

(21) Appl. No.: 15/145,129

(22) Filed: May 3, 2016

Related U.S. Application Data
(63) Continuation of application No. PCT/AT2014/000193, filed on Oct. 27, 2014.

(30) Foreign Application Priority Data
Nov. 14, 2013 (AT) A 881/2013

(51) Int. Cl. A47B 88/04; E05F 15/611; A47B 97/00

(52) U.S. Cl. CPC A47B 88/0414; A47B 88/0477; A47B 97/00; E05F 15/611; A47B 2088/0459; A47B 2220/0091; E05Y 2900/20; E05Y 2201/434

(57) ABSTRACT

The invention relates to a furniture drive (4) for ejecting a moveable furniture part (3) from a closed end position relative to the body of the item of furniture (2), comprising; a housing (9), an electric drive unit (10) which is arranged in or on the housing (9), an ejection lever (12) which can be driven by the electric drive unit (10) for transferring a movement to the moveable furniture part (3). The ejection lever (12) is mounted so that it can rotate about a rotational axis (11) on one side and comprises a free lever end (13) on the other side. Said ejection lever (12) comprises an ejection surface (14) between the rotational axis (11) and the free lever end (13). Said ejection surface (14) of the ejection lever (12) comprises, at least in sections, a toothing (15).

The present invention concerns a furniture drive for ejecting a moveable furniture part from a closed end position relative to a furniture carcass, including:
a housing,
an electric drive unit arranged in or on the housing,
an ejection lever which can be driven by the electric drive unit for transmitting a movement to the moveable furniture part,
wherein the ejection lever on the one hand is mounted rotatably about an axis of rotation and on the other hand has a free lever end, wherein between the axis of rotation and the free lever end the ejection lever has an ejection surface.

In addition, the invention concerns an arrangement having a furniture drive of the kind to be described and a force transmission device for transmitting a force to the furniture part to be ejected.

AT 504 838 B1 discloses a furniture drive having a motor-driven ejection lever, wherein in the mounted position, the ejection surface of the ejection lever loosely bears against a pushrod in the closed end position of the moveable furniture part. The pushrod forms a part of a force transmission device, wherein the force exerted during the ejection process can be transmitted to the moveable furniture part by way of an intermediate space formed between the ejection lever and the moveable furniture part. In that way, even moveable furniture parts which project into the furniture carcass only to a very slight extent or even not at all (furniture doors, furniture flaps or drawers, the depth of which is substantially less than the depth of the furniture carcass) can be ejected from the closed end position.

In the known furniture drives having an ejection lever, the ejection surface of the ejection lever bears loosely against the furniture part to be ejected or against a force transmission portion. Transmission of the movement in the ejection process is thereby effected in a force-locking relationship by way of the ejection surface being slidingly supported against the moveable furniture part or the force transmission portion, wherein a relatively low level of efficiency can be achieved due to the occurring slippage.

The object of the present invention is to provide a furniture drive of the general kind set forth in the opening part of this specification, with an improved force transmission possibility.

According to the invention, that is achieved by the features of claim 1. Further configurations of the invention are recited in the appendant claims.

According to the invention, it is provided that the ejection surface of the ejection lever at least region-wise has a tooth arrangement.

The provision of a tooth arrangement at the ejection surface of the ejection lever makes it possible to provide for a positively locking transmission of force, whereby substantially higher forces can be transmitted in comparison to a force-locking transmission. The positively locking transmission permits slippage-free, angularly accurate transmission of the rotary movement of the ejection lever with a high level of efficiency.

In an embodiment, it can be provided that the tooth arrangement of the ejection lever has at least one curved portion. In that case, the tooth arrangement can be of such a configuration that, upon ejection of the moveable furniture part from the closed end position (that is to say when the electric drive unit only slowly starts), a high transmission of force with a low travel transmission is provided. In that way, a particularly high level of torque is available when starting from the closed end position so that even heavily loaded drawers can easily be ejected from the closed end position. The transmission ratio can then decrease, starting from the closed end position of the moveable furniture part, over a predetermined range of rotary angular movement of the ejection lever so that the force transmission decreases and the travel transmission increases.

The tooth arrangement of the ejection lever can at least portion-wise be in the form of an eccentric tooth arrangement. More specifically, when using such an eccentric tooth arrangement, variable torque configurations can be implemented with a constant drive output from the electric drive unit. While, when using gear transmissions with a constant transmission ratio, the entire tooth arrangement as well as the electric drive unit must always be designed in relation to the maximum torque occurring, in the case of an eccentric tooth arrangement with a variable transmission, the required drive torque pattern can be optimized in accordance with a constantly low drive moment. The eccentric transmission can be in the form of a rotatable gear transmission or also in the form of a tooth segment.

In accordance with an embodiment, the tooth arrangement is connected in a motionally coupled relationship to the ejection lever or, alternatively, the tooth arrangement is made in one piece together with the ejection lever. The tooth arrangement can be connected, for example, in the form of a fitment portion to the ejection lever, or alternatively, the tooth arrangement can be in the form of an inherent part of the ejection lever. Production of such an ejection lever is easily possible, for example by way of an injection molding process.

In a further embodiment, the ejection lever can be designed to be variable in length by the arrangement of the tooth arrangement, wherein the length of the ejection lever is adjustable by way of an adjusting device. Alternatively, to increase the length of the ejection lever, the tooth arrangement can be fitted in the form of a fitment portion onto the ejection lever, preferably onto the free end thereof.

For reducing the production of noise, the tooth arrangement and/or a counterpart tooth arrangement cooperating with the tooth arrangement can be at least region-wise provided with a sound-damping coating.

The arrangement according to the invention is characterized by a furniture drive of the kind described and by a force transmission device, the tooth arrangement of the ejection lever cooperating with a counterpart tooth arrangement of the force transmission device. In that case, the counterpart tooth arrangement can be provided on a gear, a gear portion, a toothed lever, a pulley or on a toothed belt of the force transmission device.

Further details and advantages of the present invention will be apparent from the exemplary embodiments illustrated in the Figures in which:

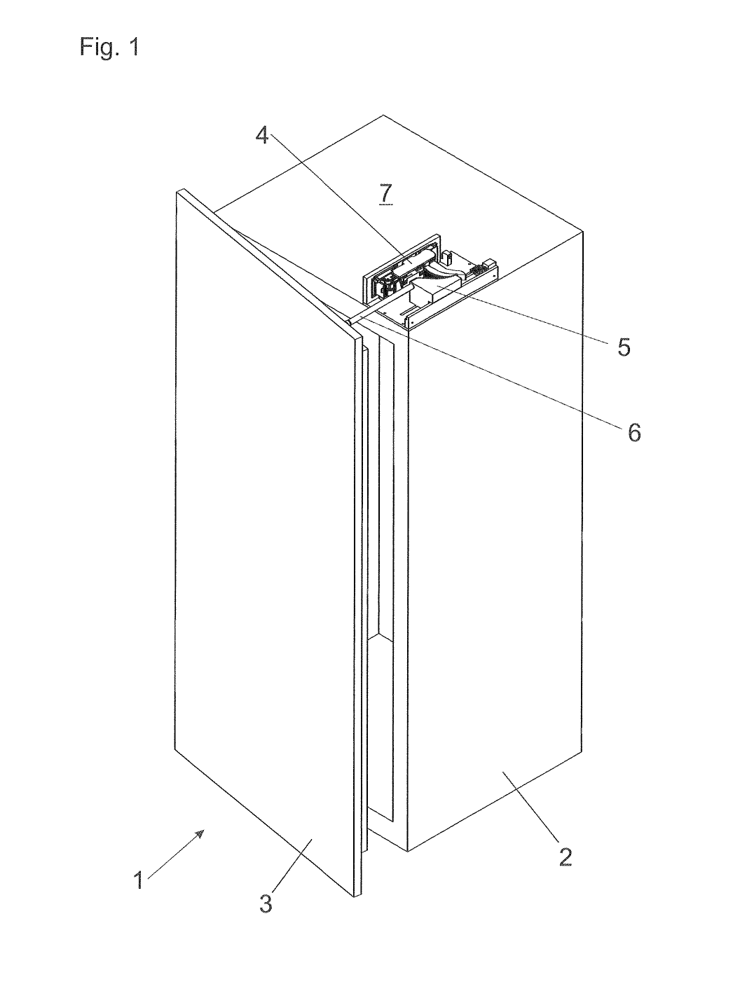

FIG. 1 shows a perspective view of an article of furniture including a furniture carcass and a furniture part mounted moveably relative thereto,

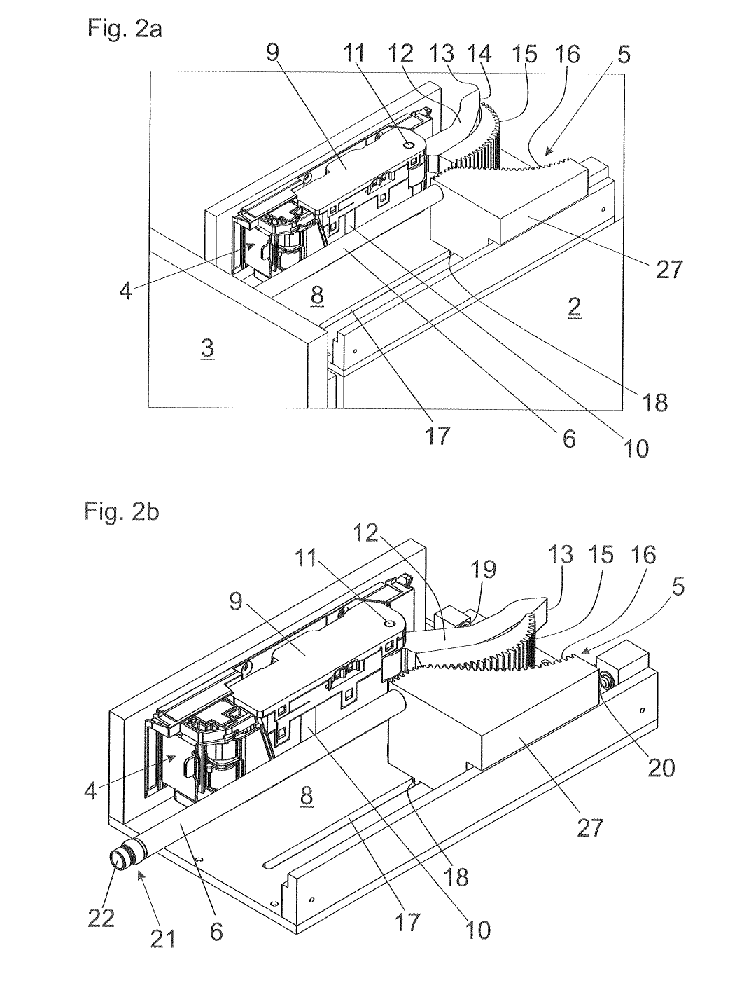

FIGS. 2a, 2b show the furniture drive and a force transmission device in the mounted position to the furniture carcass and as a perspective view,

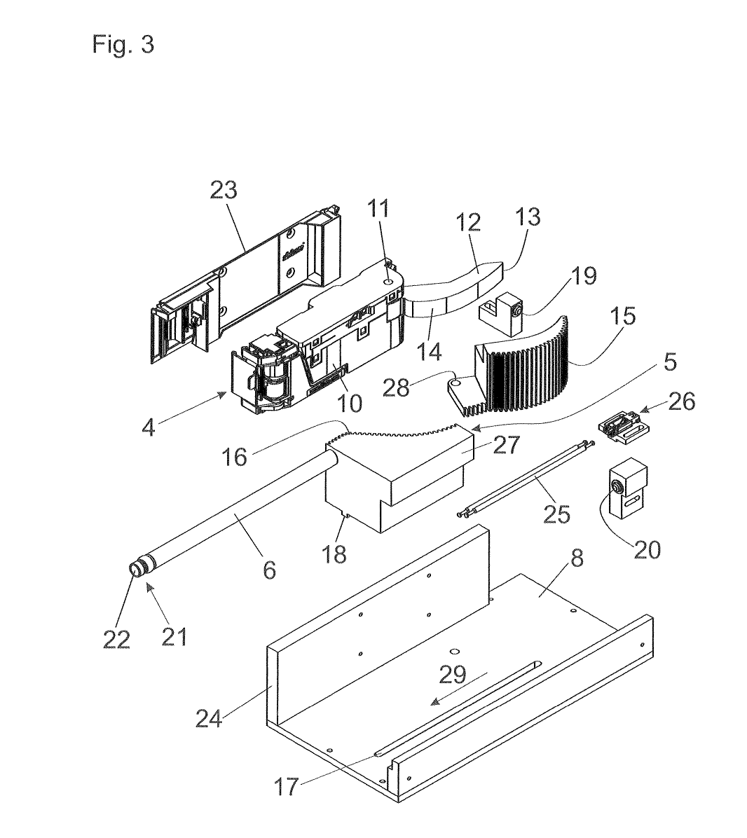

FIG. 3 shows an exploded view of the furniture drive and the force transmission device,

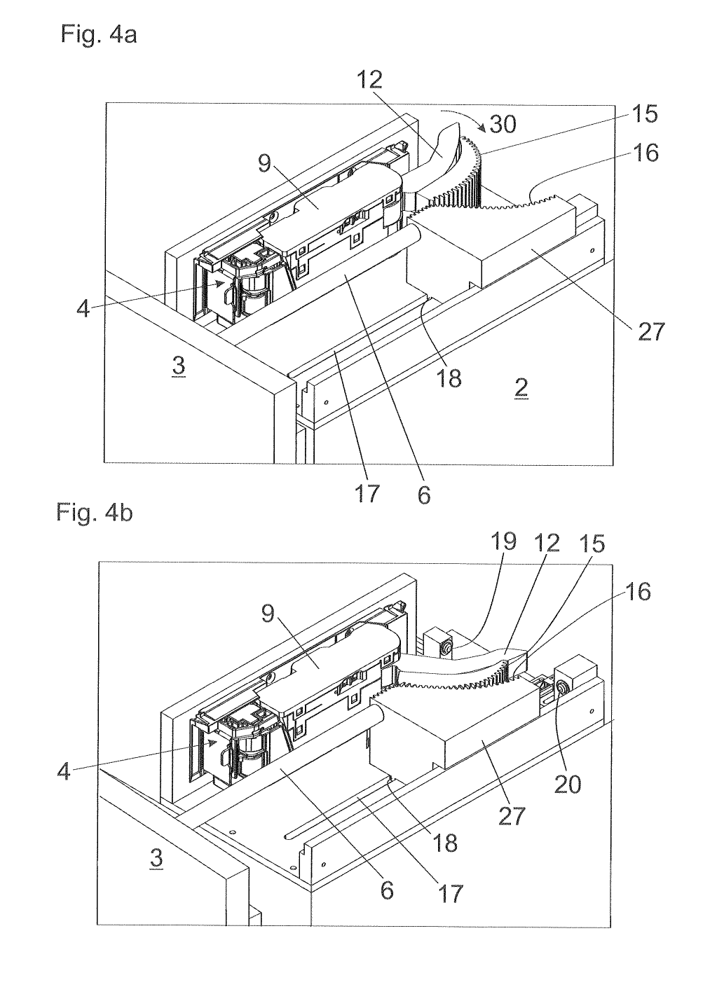

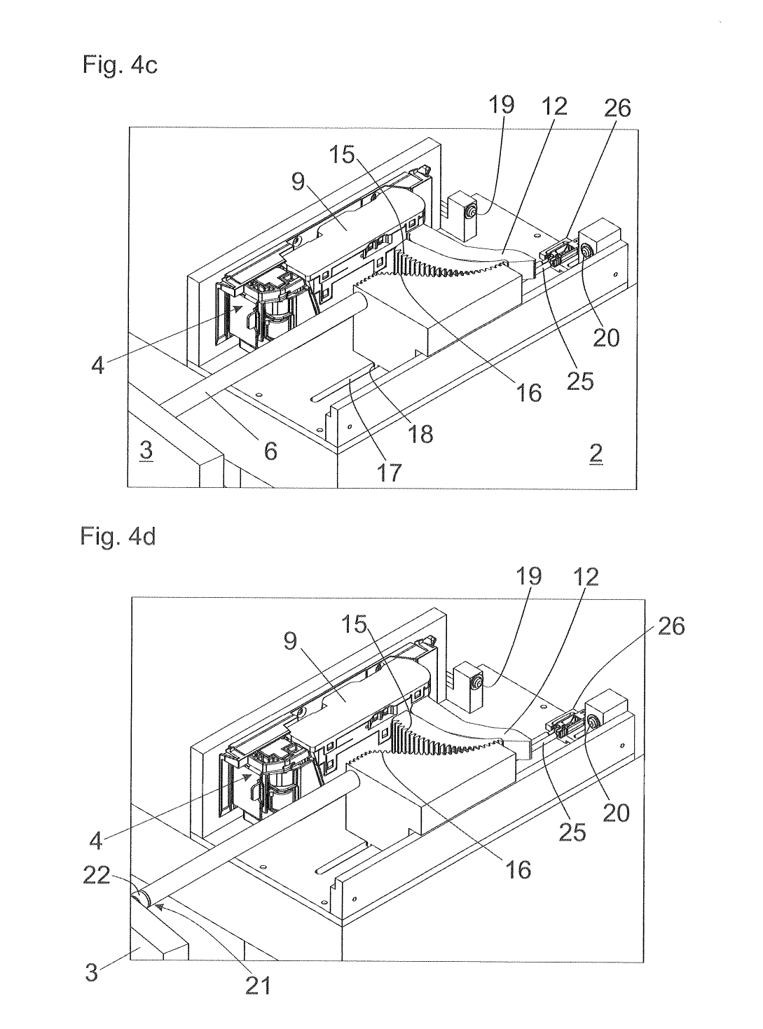

FIGS. 4a-4d show perspective views showing the time sequences of the ejection process of the moveable furniture part starting from the closed end position,

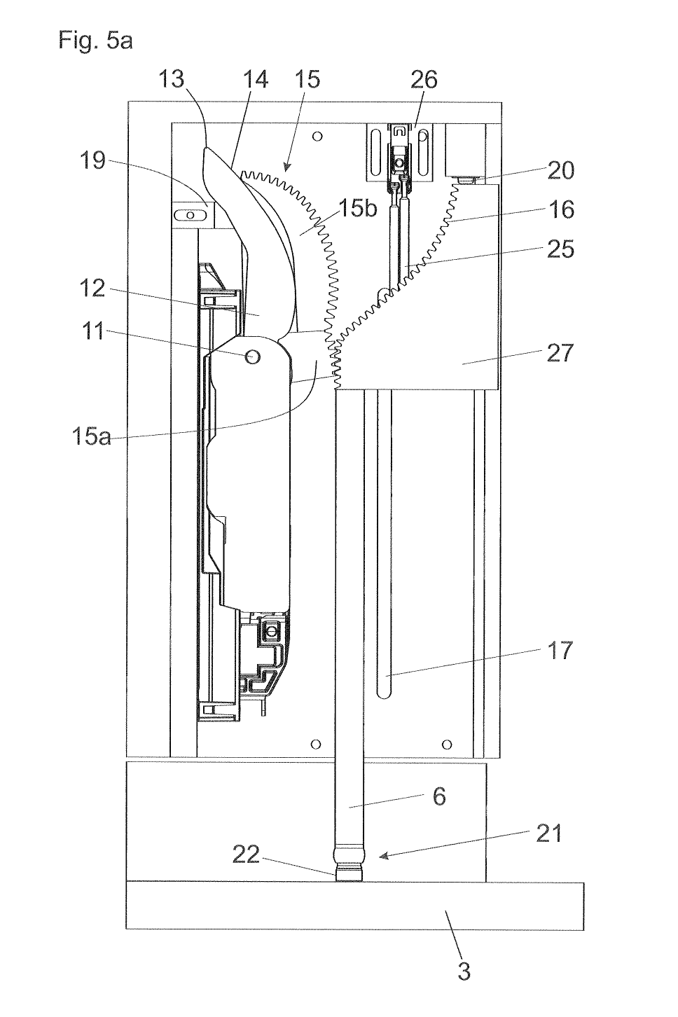

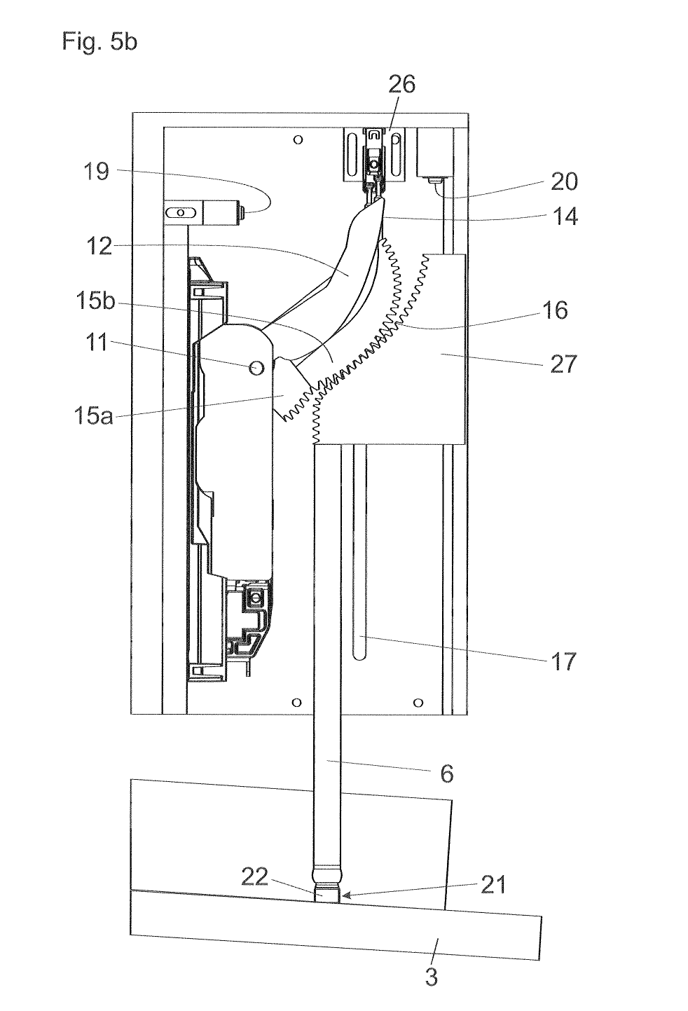

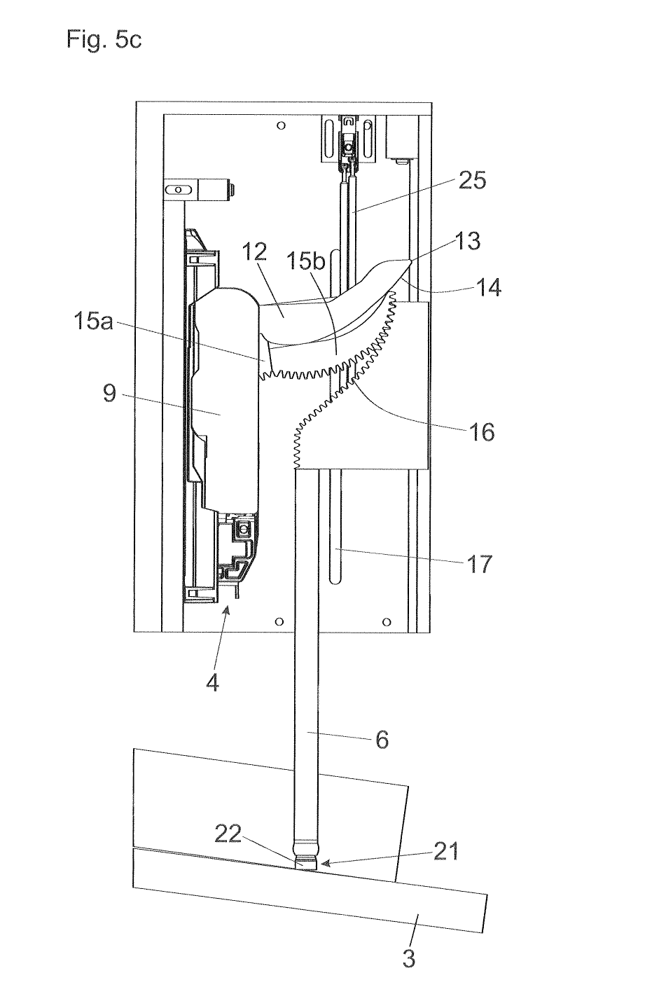

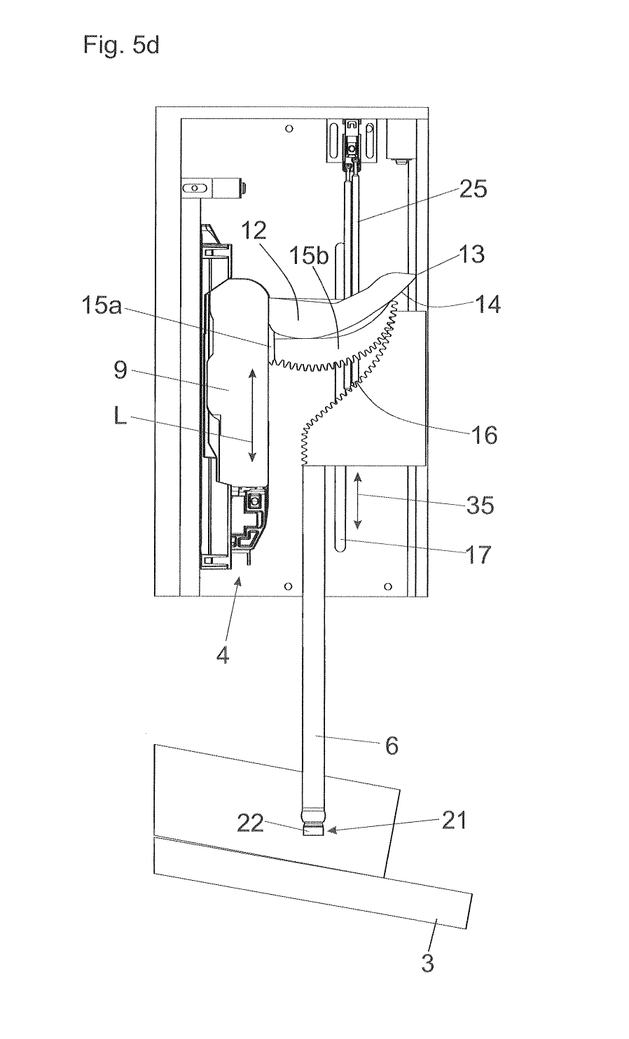

FIGS. 5a-5d show a plan view, showing the time sequences of the ejection process of the moveable furniture part starting from the closed end position, and

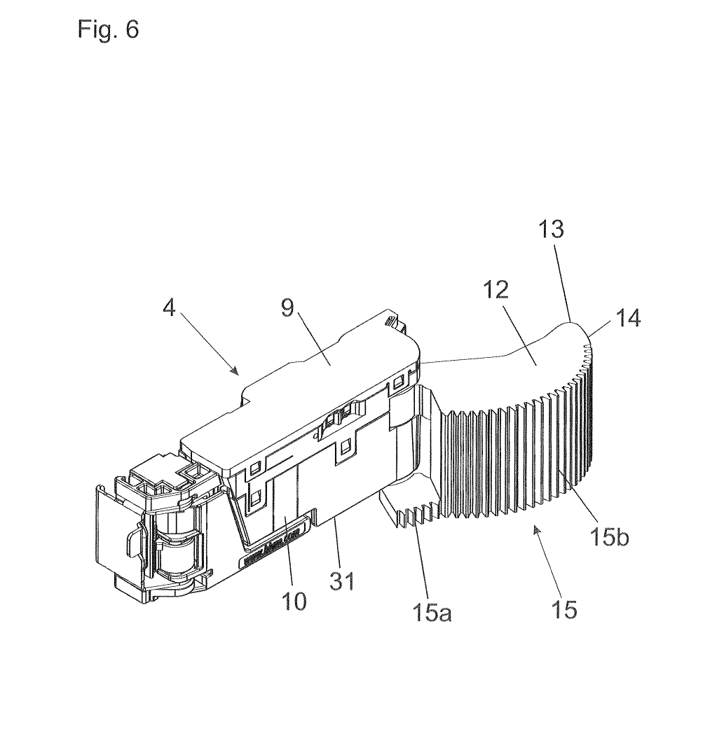

FIG. 6 shows a further embodiment of a furniture drive, wherein the ejection lever is made in one piece together with a tooth arrangement.

FIG. 1 shows a perspective view of an article of furniture 1 having a furniture carcass 2 and a furniture part 3 moveable relative thereto. In the illustrated embodiment, the moveable furniture part 3 is in the form of a door which is pivotally mounted about a vertical axis relative to the furniture carcass 2. A furniture drive 4 and a force transmission device 5 for transmitting a force to the moveable furniture part 3 are mounted on the cabinet top 7 of the furniture carcass 2, wherein the moveable furniture part 3 can be ejected from the closed end position by way of a moveably mounted pushrod 6. For that purpose, the moveable furniture part 3 projects above the cabinet top 7 of the furniture carcass 2 so that the rear side of the moveable furniture part 3 forms an abutment surface for the extendable pushrod 6.

FIG. 2a shows an enlarged view of the furniture drive 4 arranged on the furniture carcass 2, and the force transmission 5, as shown in FIG. 1. The furniture drive 4 is mounted to a base plate 8 to be fixed to the furniture carcass 2 and includes a housing 9 in which an electric drive unit 10 having a transmission for driving an ejection lever 12 is arranged. The ejection lever 12 is pivotally mounted relative to the housing 9 about an axis of rotation which preferably extends vertically in the mounted position. Triggering of the electric drive unit 10 can be effected by means of sensors which detect a (closing) movement of the moveable furniture part 3, produced manually by a user. Simple triggering capability for the furniture drive 4 is afforded by a Touch-Latch functionality. For that purpose, it can be provided that a sensor, preferably a rotary potentiometer, is provided for detecting the angular position of the ejection lever 12, wherein the signals of the sensor can be fed to an open-loop or closed-loop control unit of the furniture drive 4 and the electric drive unit 10 can be controlled or regulated by of the open-loop or closed-loop control unit. The ejection lever 12 has an ejection surface 14 which is arranged between the axis of rotation 11 and the free end 13 of the ejection lever 12 and which is provided with a tooth arrangement 15 for a positive transmission of force. In the illustrated embodiment, the tooth arrangement 15 is pivotally and coaxially mounted with respect to the axis of rotation 11 of the ejection lever 12 and is connected thereto in a motionally coupled relationship so that, upon a pivotal movement of the ejection lever 12, the tooth arrangement 15 also moves therewith. The tooth arrangement 15 of the ejection lever 12 is at least portion-wise in the form of an eccentric tooth arrangement so that a variable torque can be transmitted to the moveable furniture part 3. The force transmission device 5 includes a counterpart tooth arrangement 16 which is connected to the pushrod 6 and which cooperates with the tooth arrangement 15 of the ejection lever 12. The pushrod 6 is mounted linearly displaceably—preferably along a guide 17—relative to the base plate 8, wherein in the illustrated Figure, a slider 27, which is connected to the pushrod 6, having a guide element 18 in the form of a rib is mounted displaceably along the guide 17.

FIG. 2b shows a perspective view of the furniture drive 4 with the cooperating force transmission device 5. Abutments 19 and 20 which are preferably resilient are provided to delimit the inner end position of the ejection lever 12 and to delimit the inner end position of the slider 27. The moveable furniture part 3 can be held in the fully closed position and/or can be moved into the fully closed position towards the end of the closing movement by a closing retaining device 21. The closing retaining device 21 includes at least two parts, a first part 22 being arranged or provided on the pushrod 6 and a second part (not shown) being arranged or provided on the moveable furniture part 3, wherein the part 22 in the closed position of the moveable furniture part 3 exerts a magnetic attraction force on the part corresponding on the moveable furniture part 3. The part 22 in the form of a magnet is mounted moveably relative to the pushrod 6 in a transverse direction relative to the longitudinal direction of the pushrod 6, in particular in a horizontal and/or vertical direction. In addition, a spring device 25 (FIG. 3) can be provided by which the pushrod 6 and/or the ejection lever 12 can again be returned into a ready position after an ejection process.

FIG. 3 shows an exploded view of the arrangement with the furniture drive 4 and the force transmission device 5. The base plate has a guide 17 extending in the ejection direction 29 of the pushrod 6 and along which a guide element 18 of the slider 27 is displaceably guided. In this case, the ejection direction 29 of the pushrod 6 extends transversely relative to the (main) ejection direction of the ejection lever 12. In the illustrated embodiment, the pushrod 6 is formed in one piece together with the slider 27, the guide element 18 and the counterpart tooth arrangement 16. The furniture drive 4 with the housing 9 can be releasably fixed by way of a snap-connection to a mounting profile member 23 which is to be screwed to a plate 24 extending vertically when mounted. The furniture drive 4 includes an ejection lever 12 which is pivotally mounted about an axis of rotation 11 and which has an ejection surface 14 provided with a tooth arrangement 15. The tooth arrangement 15 is mounted about a pivot axis 28 and is motionally coupled to the ejection lever 12. Besides the resilient abutments 19, 20 for delimiting the inner end position of the ejection lever 12 and the pushrod 6, there is provided a spring device 25 including at least one tension spring in the form of a coil spring. The spring device 25 is anchored with a first end region to the pushrod 6 and with a second end region to a, preferably displaceable, spring base 26. The pushrod 6 and/or the ejection lever 12 can again be returned into a ready position by the spring device 25. A first part 22 of the closing retaining device 21 is arranged at the free end of the pushrod 6, wherein the part 22 magnetically cooperates with a corresponding part arranged or provided on the moveable furniture part 3. The magnetic holding force of the closing retaining device 21 can be of such a magnitude that the moveable furniture part 3 will not be detached from the part 22 of the pushrod 6 after an ejection process has taken place, so that it is only a user who detaches the moveable furniture part 3 from the pushrod 6 after overcoming the magnetic holding force. That represents a safety aspect, because the moveable furniture part 3, after incorrect triggering (for example by virtue of the moveable furniture part 3 being pressed in by small children or domestic animals), will not be released on its own from the pushrod 6, whereupon after a predetermined period of time, a return movement of the ejection lever 12 is possible by way of an open-loop or closed-loop control unit of the furniture drive 4, and thus also retraction of the moveable furniture part 3 (which is magnetically coupled to the pushrod 6) by the force of the spring device 25 into the closed end position is attained.

FIGS. 4a-4d show a time sequence of the ejection process of the moveable furniture part 3. Starting from the closed position shown in FIG. 4a, after activation of the electric drive unit 10, the ejection lever 12 is pivoted out in the direction of the illustrated arrow 30, in which case the tooth arrangement 15 of the ejection lever 12 cooperates with the counterpart tooth arrangement 16 of the force transmission device 5.

FIG. 4b shows the pushrod 6 after a slight extension movement, with the moveable furniture part 3 also being slightly opened. FIG. 4c shows a further open position of the pushrod 6, wherein the tooth arrangement 15 and the counterpart tooth arrangement 16 move against each other and a positively locking transmission of force is provided. FIG. 4d shows a further open position of the pushrod 6, with the part 22 of the retaining device 21 being magnetically coupled to the moveable furniture part 3. When the fully open position of the pushrod 6 is reached, a user can release the moveable furniture part 3 from the magnetic coupling by gripping behind same and can move it further towards the open position. If, in contrast, the magnetic coupling between the part 22 and the moveable furniture part 3 is not released by the action of the user, then, after a predetermined period of time and with the magnetic coupling being maintained, the moveable furniture part 3 is again pulled into the completely closed position. It will be appreciated that a corresponding part of the retaining device 21 is to be arranged or provided on the moveable furniture part 3 so that a magnetic attraction force can be produced between the part 22 and the moveable furniture part 3. Alternatively, it is for example also possible for the moveable furniture part 3 to be at least region-wise of a metallic nature, in which case the magnetic part 22—possibly by the interposition of a plastic lining for noise reduction—is operative directly on a metallic region of the moveable furniture part 3. Thus, it is also possible to open and close doors of tool cupboards, refrigerators, dishwashers or ovens by the provided structure.

FIGS. 5a-5d show a plan view of time sequences of the ejection process of the moveable furniture part 3 starting from the closed end position. FIG. 5a shows the closed end position of the moveable furniture part 3, this Figure therefore corresponding to the view in FIG. 4a. At the beginning of the ejection process, both the ejection lever 12 and also the pushrod 6 by way of the slider 27 bear against the abutments 19 and 20 associated therewith. The tooth arrangement 15 includes a first portion 15a and an adjoining second portion 15b, wherein a movement of the pushrod 6, in a first range of rotary angular movement of the ejection lever 12, is effected by the cooperation of the first portion 15a with a corresponding portion of the counterpart tooth arrangement 16, with a high transmission of force and with a low travel transmission. More specifically, at the beginning of the ejection process, there is effectively a shorter force arm (that is to say the spacing between the axis of rotation 11 and that location at which the tooth arrangement 15 and the counterpart tooth arrangement 16 are in contact with each other), whereby a predetermined torque M of the electric drive unit 10 is converted into a greater force F acting on the moveable furniture part 3.

FIG. 5b-5d shows the further sequence in the ejection process, wherein in FIG. 5b the portion 15a is already out of engagement with the counterpart tooth arrangement 16. In a second range of rotary angular movement which adjoins the first range, movement of the pushrod 6 takes place with a lower force transmission which is reduced upon a further ejection movement of the ejection lever 12. The force transmitted to the pushrod 6 therefore decreases, but a faster extension movement of the pushrod 6 is implemented. Now therefore the portion 15b in the form of the eccentric tooth arrangement cooperates with the counterpart tooth arrangement 16, in which case the slider 27 with the pushrod 6 connected thereto is moved in the direction of the open position with a higher travel transmission. FIG. 5c shows a further open position of the pushrod 6, from which it can be clearly seen that the ejection travel of the pushrod 6 can be increased by the eccentric configuration of the tooth arrangement 15 and the counterpart tooth arrangement 16. In FIG. 5d, the moveable furniture part 3 was moved by manually exerting a pulling force in the direction of the open position and after release of the magnetic coupling of the part 22 of the restraining device 21, into a further open position, and can subsequently be moved freely. It can be seen from FIGS. 5a-5d that in the mounted condition of the furniture drive 4, the location at which the tooth arrangement 15 and the counterpart tooth arrangement 16 are in contact with each other moves in the direction towards the free end 13 of the ejection lever 12 (see FIG. 5c) upon ejection of the moveable furniture part 3, starting from the proximity of the axis of rotation 11 of the ejection lever 12 (see FIG. 5a), wherein there is a substantially uniform change in the force arm and violent changes in the exerted force are avoided. It is also possible to see a particular advantage of the invention, namely that the illustrated structure permits a deflection of force and thus also an angular ejection of the pushrod 6 in relation to the ejection direction of the ejection lever 12. More specifically, it is possible in illustrated FIG. 5b to see the direction 35 of the linear movement of the pushrod 6, which extends substantially parallel to a longitudinal direction (L) of the housing 9 of the furniture drive 4.

FIG. 6 shows a furniture drive 4 according to a further embodiment, the tooth arrangement 15 being made in one piece together with the ejection lever 12. The tooth arrangement 15 includes a first portion 15a and a second portion 15b, wherein those two portions 15a, 15b are respectively of a differently curved configuration. In order for the first portion 15a of the tooth arrangement 15 to be pivoted inwardly beneath the housing 9 of the furniture drive 4 upon ejection of the ejection lever 12, it is possible to provide at the underside 31 of the housing 9 knobs (not visible here) which space the underside 31 of the housing 9 from the base plate 8 so that the first portion 15a can pivot inwardly under the housing 9.

In a possible embodiment of the invention, the furniture drive 4 can be assembled together with the force transmission device 5 in a housing of a common constructional unit, in which case only the pushrod 6 is extended out of the housing of that common unit.

1. A furniture drive for ejecting a moveable furniture part from a closed end position relative to a furniture carcass, including:
a housing,
an electric drive unit arranged in or on the housing,
an ejection lever which can be driven by the electric drive unit for transmitting a movement to the moveable furniture part,
wherein the ejection lever on the one hand is mounted rotatably about an axis of rotation and on the other hand has a free lever end, wherein between the axis of rotation and the free lever end the ejection lever has an ejection surface,
wherein the ejection surface of the ejection lever at least portion-wise has a tooth arrangement.

2. The furniture drive according to claim 1, wherein the tooth arrangement includes at least one curved portion.

3. The furniture drive according to claim 1, wherein the tooth arrangement is at least portion-wise in the form of an eccentric tooth arrangement.

4. The furniture drive according to claim 1, wherein the tooth arrangement is connected in motionally coupled relationship to the ejection lever or that the tooth arrangement is made in one piece together with the ejection lever.

5. An arrangement having a furniture drive according to claim 1 and a force transmission device for transmitting a force to the moveable furniture part, wherein the tooth arrangement of the ejection lever cooperates with a counterpart tooth arrangement of the force transmission device.

6. The arrangement according to claim 5, wherein the force transmission device has at least one moveably mounted pushrod for ejecting the moveable furniture part, wherein the counterpart tooth arrangement is connected to the pushrod.

7. The arrangement according to claim 5, wherein the counterpart tooth arrangement is at least portion-wise of a curved configuration.

8. The arrangement according to claim 5, wherein in the mounted condition of the furniture drive, the location at which the tooth arrangement and the counterpart tooth arrangement are in mutual contact moves upon ejection of the moveable furniture part, starting from the proximity of the axis of rotation of the ejection lever in the direction towards the free lever end of the ejection lever, wherein a substantially uniform change in the force arm occurs.

9. The arrangement according to claim 6, wherein the pushrod is mounted linearly displaceably—preferably along a guide.

10. The arrangement according to claim 9, wherein the ejection direction of the pushrod extends transversely relative to the ejection direction of the ejection lever.

11. The arrangement according to claim 6, wherein there is provided a spring device by which the pushrod and/or the ejection lever can again be returned into a ready position after an ejection process.

12. The arrangement according to claim 6, wherein in the closed end position of the moveable furniture part, the pushrod bears against the moveable furniture part.

13. The arrangement according to claim 12, wherein there is provided a closing retaining device by which the moveable furniture part is held in the fully closed position and/or is moveable into the fully closed position.

14. The arrangement according to claim 13, wherein the closing retaining device includes at least two parts, wherein a first part is arranged or provided on the pushrod and a second part is arranged or provided on the moveable furniture part, wherein the two parts exert a magnetic attraction force on each other in the closed position of the moveable furniture part.

15. The arrangement according to claim 6, wherein the housing of the furniture drive has a longitudinal direction, wherein the direction of the linear movement of the pushrod extends substantially parallel to the longitudinal direction of the housing.
